(19) United States
(12) Patent Application Publication
(10) Pub. No.: US 2022/0212505 A1
(43) Pub. Date: Jul. 7, 2022

(54) PNEUMATIC TIRE

(71) Applicant: KUMHO TIRE CO., INC., Gwangju (KR)

(72) Inventors: Chang Jung PARK, Gwangju (KR); Jae Moon LEE, Gwangju (KR); Tae Min KIM, Gwangju (KR); Soo Min KIM, Gwangju (KR)

(21) Appl. No.: 17/448,465

(22) Filed: Sep. 22, 2021

(30) Foreign Application Priority Data
Jan. 6, 2021 (KR) 10-2021-0001500

(51) Int. Cl. B60C 11/13

(52) U.S. Cl. CPC B60C 11/1307; B60C 2011/1338

(57) ABSTRACT

A pneumatic tire includes a tread portion having a tread surface for making contacting with a road surface and a groove recessed inward from the tread surface and extending along a circumferential direction, and a plurality of noise reflectors protruding from the groove and disposed spaced apart from each other along the circumferential direction. The groove includes a groove bottom surface spaced apart by a predetermined distance from the tread surface in a radial direction of the pneumatic tire and a plurality of groove side surfaces connected to the groove bottom surface and each including a connection curved surface having a predetermined curvature. Each of the noise reflectors includes a support surface supported by the connection curved surface and the groove bottom surface and a protrusion surface located on a side opposite to the support surface and disposed to be spaced apart from the connection curved surface.

### CROSS-REFERENCE TO RELATED APPLICATION

This application claims priority to Korean Patent Application No. 10-2021-0001500 filed on Jan. 6, 2021, the disclosures of which are incorporated herein in its entirety by reference for all purposes.

### TECHNICAL FIELD

The present disclosure relates to a pneumatic tire, and more particularly, a pneumatic tire formed so that noise generated from a groove is reduced by disposing a noise reflector in the groove.

### BACKGROUND

Tires are mounted on a variety of vehicles, from small vehicles to heavy-duty vehicles, to support loads of the vehicles, and to perform a power transmission function that transmit power of the vehicles to the ground and a brake function, as well as functions for dampening vibrations and shocks from the ground that occur when the vehicles travel. In order to perform the functions of the tires, an internal air pressure is applied to the tires which play an important part in traveling and braking of the vehicles.

### SUMMARY

The present disclosure provides a pneumatic tire formed so that noise generated from a groove can be reduced.

In accordance with an embodiment of the present disclosure, there is provided a pneumatic tire for reducing noise including: a tread portion including: a tread surface for making contacting with a road surface; and a groove recessed inward from the tread surface and extending along a circumferential direction of the pneumatic tire; and a plurality of noise reflectors protruding from the groove and disposed spaced apart from each other along the circumferential direction of the pneumatic tire, wherein the groove includes: a groove bottom surface spaced apart by a predetermined distance from the tread surface in a radial direction of the pneumatic tire; and a plurality of groove side surfaces connected to the groove bottom surface and each including a connection curved surface having a predetermined curvature, wherein each of the noise reflectors includes: a support surface supported by the connection curved surface and the groove bottom surface; and a protrusion surface located on a side opposite to the support surface and disposed to be spaced apart from the connection curved surface, and wherein the protrusion surface includes a protruding curved surface having a shape which goes away from a central virtual plane perpendicular to the groove bottom surface as it goes from the groove bottom surface toward an outer side in the radial direction of the pneumatic tire.

The pneumatic tire may have a meridian plane passing through a center of the pneumatic tire and perpendicular to an axial direction of the tire, the plurality of groove side surface may include a first groove side surface and a second groove side surface, the first groove side surface and the second groove side surface may be inclined so that an axial gap therebetween decreases as it goes to the groove bottom surface from the tread surface, and each of the first groove side surface and the second groove side surface may extend to be inclined with respect to the meridian surface.

A height of the noise reflector in the radial direction may be ½ or more of a length between the tread surface and the groove bottom surface.

A thickness of the noise reflector in the circumferential direction may be equal to or smaller than a separation distance between centers of the plurality of noise reflectors in the circumferential direction.

The tread portion may further include a sipe recessed inward from the tread surface and extending in a direction deviating from an extension direction of the groove to be connected to the groove, and the noise reflector may be disposed to be spaced apart from the sipe in the circumferential direction of the pneumatic tire.

According to embodiments of the present disclosure, a noise reflector may be disposed in the groove of the pneumatic tire, and thus, noise generated by the groove may be reduced.

### BRIEF DESCRIPTION OF THE DRAWINGS

FIG. 1 is a plan view of a pneumatic tire according to a first embodiment of the present disclosure.

FIG. 2 is a perspective view of a noise reflector disposed in a groove according to the first embodiment of the present disclosure.

FIG. 3 is a cross-sectional view of the groove according to the first embodiment of the present disclosure.

FIG. 4 is a partial cross-sectional view of a pneumatic tire taken along line IV-IV of FIG. 1.

FIGS. 5A to 5C are cross-sectional views of the noise reflector according to the first embodiment of the present disclosure.

FIG. 6 is an enlarged view of K illustrated in FIG. 1.

FIG. 7 is a table illustrating a level of noise generated by the pneumatic tire according to the first embodiment of the present disclosure.

FIG. 8 is a graph illustrating a noise evaluation result of the pneumatic tire according to the first embodiment of the present disclosure.

FIG. 9 is a table illustrating results of evaluating drainage performance of the pneumatic tire according to the first embodiment of the present disclosure.

FIGS. 10A and 10B are cross-sectional views of side surfaces of a plurality of grooves of a pneumatic tire according to a second embodiment of the present disclosure.

### DETAILED DESCRIPTION

With the change of the times, a proportion of unpaved roads gradually decreases, vehicles without an internal combustion engine such as electric vehicles are popularized, and noise is recently being regarded as important among the main performance of tires. The existing tire includes a tread portion in contact with a road surface, and a groove may be formed in the tread portion. The groove improves drainage. However, air flows in the groove as the vehicle travels, and thus, pipe resonance may be generated by the flowing air. There is a problem that the pipe resonance causes noise.

Hereinafter, specific embodiments for implementing the technical spirit of the present disclosure will be described with reference to the accompanying drawings.

In describing the embodiments of the present disclosure, the detailed descriptions of well-known functions or configurations will be omitted if it is determined that the detailed descriptions of well-known functions or configurations may unnecessarily make obscure the spirit of the present disclosure.

When an element is referred to as being ‘connected’ to, or ‘contacted’ with another element, it should be understood that the element may be directly connected to, or contacted with the other element, but that other elements may exist in the middle.

The terms used in the present disclosure are only used for describing specific embodiments, and are not intended to limit the present disclosure. Singular expressions include plural expressions unless the context clearly indicates otherwise.

In addition, in the present disclosure, expressions such as an upper side, a lower side, and a side surface are described with reference to the drawings, and it should be noted in advance that if the direction of the object is changed, it may be expressed differently. For the same reason, some components in the accompanying drawings are exaggerated, omitted, or schematically illustrated, and the size of each component does not entirely reflect the actual size.

The terms used herein, including ordinal numbers such as “first” and “second” may be used to describe, and not to limit, various components. The terms simply distinguish the components from one another.

The meaning of “including” as used in the specification specifies a specific characteristic, region, integer, step, action, element and/or component, but does not exclude the existence or addition of other specific characteristic, region, integer, step, action, element, component and/or group.

Meanwhile, a radial direction “R” described below means a radial direction of a tire. An axis may mean a rotation axis of the tire, and an axial direction “A” means a direction parallel to the rotation axis of the tire. The axial direction does not necessarily pass through a center of the rotation axis of the tire, and includes a direction parallel to an extension direction of the rotation axis of the tire. In addition, a circumferential direction “C” is a direction along an outer circumferential surface of the tire and means a direction perpendicular to the radial direction. The circumferential direction may be either the clockwise direction or counterclockwise direction when viewed from a side surface of the tire.

Meanwhile, unless otherwise specified, the directions include both positive and negative directions.

Hereinafter, a pneumatic tire 1 according to a first embodiment of the present disclosure will be described with reference to the drawings.

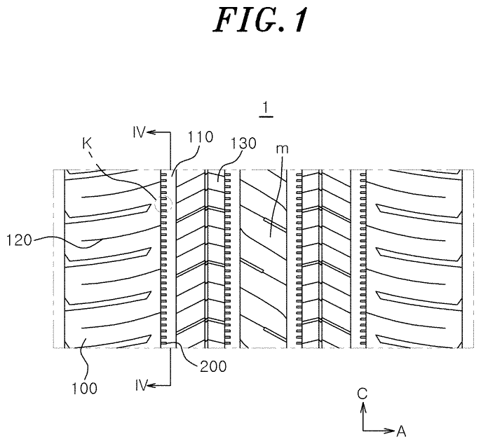

Referring to FIG. 1, the pneumatic tire 1 according to the first embodiment of the present disclosure may include a tread portion 100 and a noise reflector 200.

The tread portion 100 is disposed on an outer portion of the pneumatic tire 1, corresponds to a thick rubber layer having a configuration in which the road surface is directly grounded, and may be formed of a rubber material having strong cut, impact, and abrasion resistance to protect an inside of the tire. A surface of the tread portion 100 may extend toward a side wall (not illustrated) of the pneumatic tire 1 as a portion contacting the road surface. In addition, the tread portion 100 may include a groove 110 and a sipe 120 to improve water discharge performance, conditional friction performance, or the like.

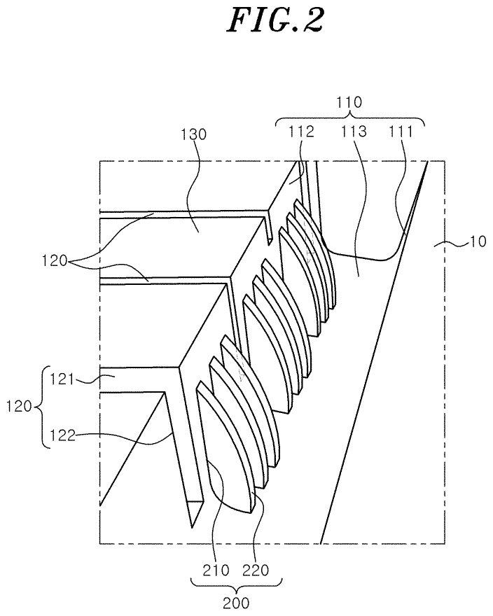

Referring further to FIG. 2, the groove 110 may be recessed inward from the surface of the tread portion 100. The groove 110 may be formed in the circumferential direction or the axial direction of the pneumatic tire 1, or may be extended in a direction deviating from the circumferential direction or the axial direction of the pneumatic tire 1. Hereinafter, the groove 110 will be described on the basis of being formed in the circumferential direction, but is not limited thereto. In addition, the groove 110 may include a plurality of grooves 110 and the plurality of grooves 110 may be disposed to be spaced apart from each other. For example, the plurality of grooves 110 formed in the circumferential direction of the pneumatic tire 1 may be disposed to be spaced apart from each other in the axial direction of the pneumatic tire 1. In addition, a width of the groove 110 perpendicular to an extension direction of the groove 110 may be 1.1 mm or more. The groove 110 may include a plurality of groove side surfaces 111 and 112 and a groove bottom surface 113.

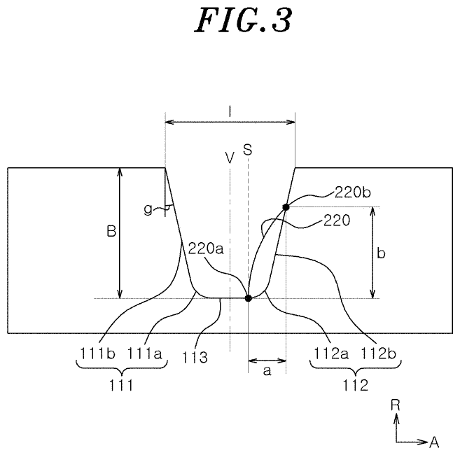

Referring further to FIG. 3, the plurality of groove side surfaces 111 and 112 may be recessed from the surface of the tread portion 100. The plurality of groove side surfaces 111 and 112 are connected to the groove bottom surface 113 and portions connected to the groove bottom surface 113 may have a predetermined curvature. The predetermined curvature may be equal to or less than R5 (5 mm), for example. In addition, the plurality of groove side surfaces 111 and 112 may include a first groove side surface 111 and a second groove side surface 112. The second groove side surface 112 may be disposed at a position more spaced apart from a center of the tread portion 100 than the first groove side surface 111. For example, in the plurality of groove side surfaces 111 and 112 of the groove 110, the second groove side surface 112 located on one side (left side of FIG. 1) in the axial direction of the pneumatic tire 1 with respect to a meridian plane “m” is located on one side (left side of FIG. 1) of the first groove side surface 111 in the axial direction of the pneumatic tire 1. In addition, in the plurality of groove side surfaces 111 and 112 of the groove 110, the second groove side surface 112 located on the other side (right side of FIG. 1) in the axial direction of the pneumatic tire 1 with respect to the meridian surface “m” is located on the other side (right side of FIG. 1) of the first groove side surface 111 in the axial direction of the pneumatic tire 1. In the present specification, the meridian plane “m” refers to a plane perpendicular to the axial direction while passing through a center of the pneumatic tire 1. In other words, in each of the grooves 110, the second groove side surface 112 is disposed to be farther from the meridian surface “m” than the first groove side surface 111 in the axial direction of the pneumatic tire 1.

In addition, the first groove side surface 111 and the second groove side surface 112 may be inclined so that a gap therebetween decreases in a direction closer to the groove bottom surface 113. For example, an angle “g” at which the first groove side surface 111 and the second groove side surface 112 are inclined may be in a range of 5° to 30° with respect to the radial direction of the pneumatic tire 1. In other words, the angle “g” formed between each of the first groove side surface 111 and the second groove side surface 112 and the meridian surface “m” may be in a range of 5° to 30°. In addition, the plurality of groove side surfaces 111 and 112 may include connection curved surfaces 111a and 112a and inclined surfaces 111b and 112b, respectively.

As described above, the connection curved surfaces 111a and 112a are portions of the groove side surfaces that are connected to the groove bottom surface 113 and formed with a predetermined curvature. The connection curved surfaces 111a and 112a may support the noise reflector 200. The first groove side surface 111 may include the first connection curved surface 111a connected to the groove bottom surface 113, and the second groove side surface 112 may include the second connection curved surface 112a connected to the groove bottom surface 113.

The inclined surfaces 111b and 112b may be located between the connection curved surfaces 111a and 112a and the surface of the tread portion 100. In addition, the inclined surfaces 111b and 112b are surfaces that may be connected to a second connection unit 220b of the noise reflector 200 to be described below. In addition, the inclined surfaces 111b and 112b may be inclined to form the angle “g” with the meridian surface “m” as described above. In other words, the first groove side surface 111 may include the first inclined surface 111b connected to the first connection curved surface 111a, and the second groove side surface 112 may include the second inclined surface 112b connected to the second connection curved surface 112a. In addition, the first inclined surface 111b and the second inclined surface 112b may be inclined so that an axial gap therebetween gradually decreases toward the groove bottom surface 113. For example, an angle “g1” between the first inclined surface 111b and the meridian surface “m” and an angle g2 between the second inclined surface 112b and the meridian surface “m” may be in a range of 5° to 30°. The angle “g1” and the angle “g2” may be the same or different from each other.

The groove bottom surface 113 may be connected to the plurality of groove side surfaces 111 and 112 and may extend in a direction parallel to the surface of the tread portion 100. In other words, the groove bottom surface 113 may be located between the first groove side surface 111 and the second groove side surface 112.

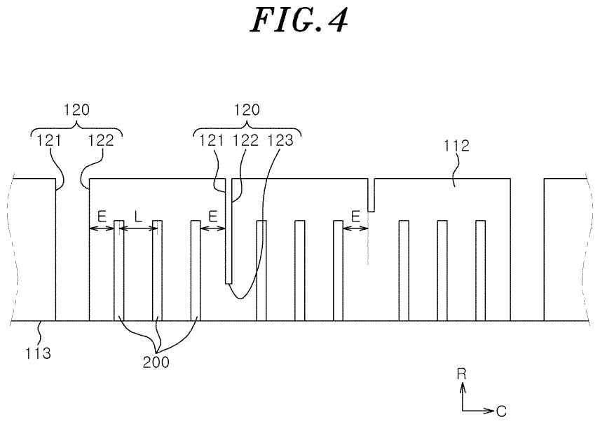

Referring further to FIG. 4, the sipe 120 may be recessed inwardly from the surface of the tread portion 100, and may be connected to the groove 110 by extending in a direction that deviates from a direction in which the groove 110 is extended. For example, the sipe 120 may extend in a direction close to the sidewall or in the axial direction of the pneumatic tire 1. In addition, a width of the sipe 120 perpendicular to an extension direction of the sipe 120 may be 1.0 mm or less. One side of the sipe 120 may be connected to the first groove side surface 111 or the second groove side surface 112 of the groove 110. In addition, the sipe 120 may be spaced apart from the noise reflector 200 in the circumferential direction of the pneumatic tire 1. In addition, some of the plurality of sipes 120 may be connected to one groove 110. The plurality of sipes 120 are connected to the groove 110, and thus, a plurality of pitches 130 may be formed on the surface of the tread portion 100. The plurality of noise reflectors 200 may be disposed between the plurality of sipes 120. In addition, the noise reflector 200 may be disposed to be spaced apart from the sipe 120 in the circumferential direction. For example, a gap “E” between the sipe 120 and the noise reflector 200 may be in a range between 1.5 mm and 3.0 mm. The gap “E” may be a gap between the sipe 120 and the noise reflector 200 formed closest to the sipe 120 among the plurality of noise reflectors 200. The sipe 120 may include a plurality of sipe side surfaces 121 and 122 and a sipe bottom surface 123.

The plurality of sipe side surfaces 121 and 122 may be recessed inward from the surface of the tread portion 10. In addition, the plurality of sipe side surfaces 121 and 122 may be connected to any one of the plurality of groove side surfaces 111 and 112. The gap “E” between the sipe 120 and the noise reflector 200 described above by the plurality of sipe side surfaces 121 and 122 may be a gap between any one of the plurality of noise reflector 200 and any one of the plurality of sipe side surfaces 121 and 122 formed closest thereto.

The sipe bottom surface 123 is connected to the plurality of sipe side surfaces 121 and 122 and may be formed in a direction parallel to the surface of the tread portion 100. In other words, the sipe bottom surface 123 may be located between the plurality of sipe bottom surfaces 123. At least a portion of the plurality of sipe bottom surfaces 123 may be disposed at different positions according to the length of the plurality of sipe side surfaces 121 and 122 being recessed from the surface of the tread portion 100. In other words, the sipe bottom surface 123 may be connected to any one of the plurality of groove side surfaces 111 and 112 or the groove bottom surface 113.

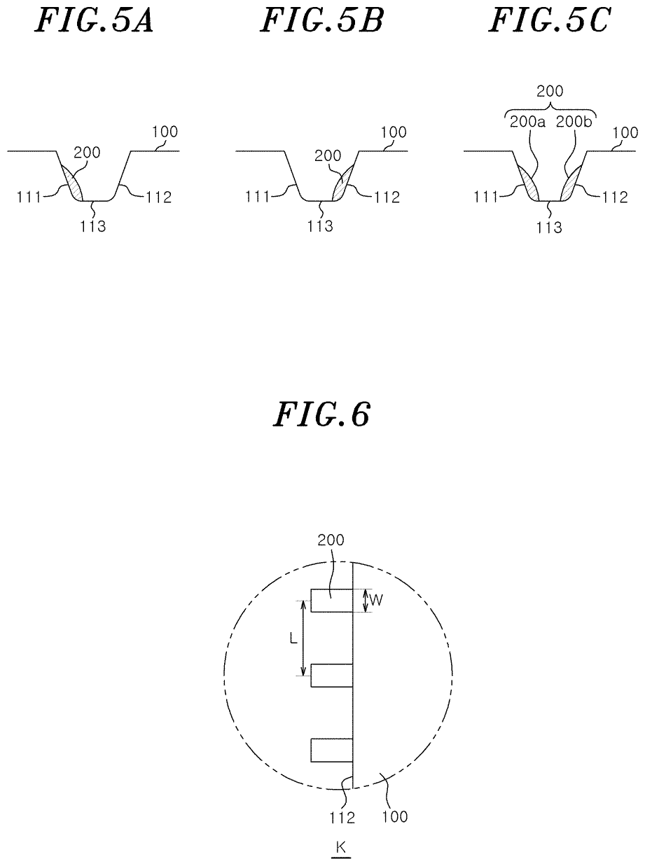

Referring further to FIGS. 5A to 5C, the noise reflector 200 may reduce noise by reducing pipe resonance generated by air flowing in the groove 110. The noise reflector 200 may protrude from the groove 110, and the plurality of noise reflectors 200 may be provided and disposed to be spaced apart from each other along the circumferential direction of the pneumatic tire 1. In addition, the noise reflector 200 may protrude from at least one of the first groove side surface 111 and the second groove side surface 112. For example, the noise reflectors 200 may protrude from the first groove side surface 111 and the groove bottom surface 113 and may be spaced apart from each other along the circumferential direction of the pneumatic tire 1. As another example, the plurality of noise reflectors 200 may protrude from the second groove side surface 112 and the groove bottom surface 113 and may be spaced apart from each other along the circumferential direction of the pneumatic tire 1. As still another example, first noise reflectors 200a which are some of the plurality of noise reflectors 200 may protrude from the first groove side surface 111 and the groove bottom surface 113 and may be disposed to be spaced apart from each other along the circumferential direction of the pneumatic tire 1, and second noise reflectors 200b which are the remainder thereof may protrude from the second groove side surface 112 and the groove bottom surface 113 and may be spaced apart from each other along the circumferential direction of the pneumatic tire 1. In addition, the first noise reflectors 200a and the second noise reflectors 200b may be spaced apart from each other.

Referring further to FIGS. 3, 4 and 6, a height “b” of the noise reflector 200 may be formed to be ½ or more of a length “B” from the surface of the tread portion 100 to the groove bottom surface 113 in the radial direction of the pneumatic tire 1. For example, the height “b” of the noise reflector 200 may be 65% or more and 75% or less of the length “B” from the surface of the tread portion 100 to the groove bottom surface 113 in the radial direction of the pneumatic tire 1. A thickness “W” of the noise reflector 200 in the circumferential direction of the pneumatic tire 1 may be 3% to 10% or less of a length of the gap between the plurality of sipes 120 or the pitch between the plurality of sipes 120, but is not limited thereto. For example, the thickness W of the noise reflector 200 may be in a range of 1.0 mm to 3.0 mm In addition, the thickness W of the noise reflector 200 may be less than or equal to a circumferential separation distance L between the centers of the plurality of noise reflectors 200. In other words, the circumferential separation distance L between the centers of the plurality of noise reflectors 200 may be 1 or more times and less than 2 times the thickness “W” of the noise reflector 200. For example, the separation distance L may be 1.0 mm or more and 6.0 mm or less. In addition, the plurality of noise reflectors 200 may be disposed in the groove 110 in a number of 300 or more and 1000 or less. The noise reflector 200 may include a support surface 210 and a protrusion surface 220.

The support surface 210 may be supported by the groove bottom surface 113 and one of the first groove side surface 111 and the second groove side surface 112. In addition, the support surface 210 may also be formed into a curved surface corresponding to the connection curved surfaces 111a and 112a. In other words, the support surface 210 may be formed in a curved surface to be supported by the connection curved surfaces 111a and 112a, the inclined surfaces 111b and 112b, and the groove bottom surface 113. For example, the support surface 210 may be supported by the first connection curved surface 111a, the first inclined surface 111b, and the groove bottom surface 113, or may be supported by the second connection curved surface 112a, the second inclined surface 112b, and the groove bottom surface 113.

The protrusion surface 220 may be located on a side opposite to the support surface 210 and may be spaced apart from the connection curved surfaces 111a and 112a. The protrusion surface 220 may be connected to the groove bottom surface 113 and one of the first groove side surface 111 and the second groove side surface 112. The protrusion surface 220 may include one side that is connected to the groove bottom surface 113 and the other side that is located on a side opposite to one side and connected to the first groove side surface 111 or the second groove side surface 112. Hereinafter, one side of the protrusion surface 220 will be referred to as a first connection portion 220a, and the other side of the protrusion surface 220 will be referred to as a second connection portion 220b. The first connection portion 220a and the second connection portion 220b of the protrusion surface 220 may be connected to the support surface 210. In addition, the protrusion surface 220 may include a protruding curved surface having a shape that goes away from a first virtual surface “V”, which is a virtual plane perpendicular to the groove bottom surface 113, toward an outer side in the radial direction of the pneumatic tire 1. In other words, the first connection portion 220a may be closer to the first virtual surface V than the second connection portion 220b. In addition, the protrusion surface 220 may be in contact with a second virtual surface “S”, which is a virtual plane that is perpendicular to the groove bottom surface 113 and passes through the first connection portion 220a of the protrusion surface 220.

A length “a” from the second virtual surface “S” to the second connection portion 220b of the protrusion surface 220 based on the axial direction of the pneumatic tire 1 may be 20% or more and 30% or less of a maximum gap “I” between the first groove side surface 111 and the second groove side surface 112. In other words, the noise reflector 200 may be 20% or more and 30% or less of the maximum distance “I” between the first groove side surface 111 and the second groove side surface 112 and may protrude from the groove bottom surface 113 and any one of the first groove side surfaces 111 and the second groove side surface 112.

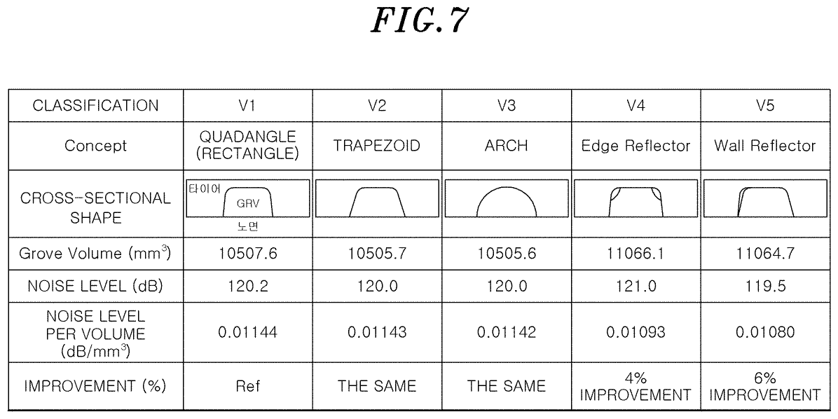

Hereinafter, operations and effects of the pneumatic tire 1 according to the first embodiment of the present disclosure will be described with further reference to FIGS. 7 to 9.

Since the noise reflector 200 is disposed in the groove 110 of the pneumatic tire 1 according to the first embodiment of the present disclosure, noise caused by the flow of air flowing in the groove 110 can be reduced.

V1, V2, and V3 illustrated in FIG. 7 are grooves having different shapes, and V4 and V5 are grooves in which different types of noise reflectors are disposed. Even when the shapes of the grooves are different, there is no change in a noise level and a noise level per unit volume. Meanwhile, as the noise reflector is provided, the noise level per unit volume was improved by 4% in V4 and by 6% or more in V5. In addition, in the noise level and the noise level per unit volume, V5 including the noise reflector formed long in the radial direction of the pneumatic tire 1 were further improved than V4. In other words, as the noise reflector 200 is provided on the groove bottom surface 113 and the groove side surfaces 111 and 112 as in V5, noise can be efficiently reduced.

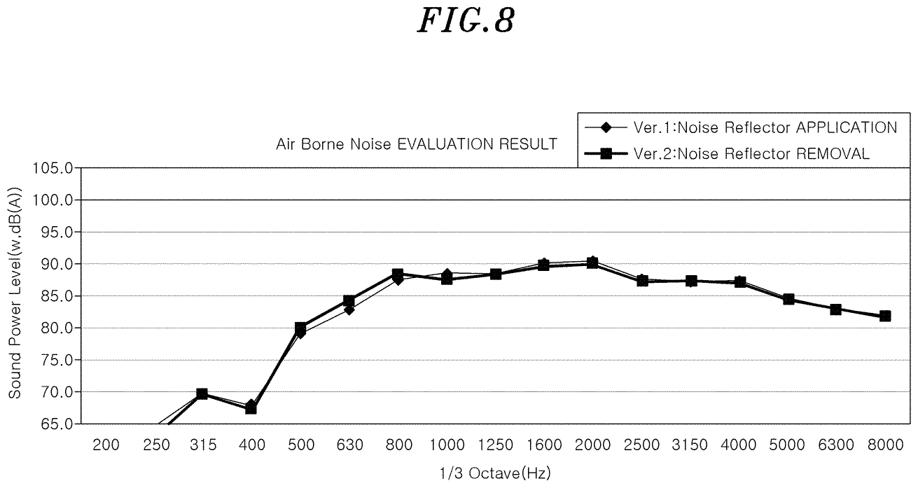

In addition, as illustrated in FIG. 8, when the noise reflector 200 is applied to the groove 110, noise can be reduced in a band of 500 hz to 800 hz than when the noise reflector 200 is not applied.

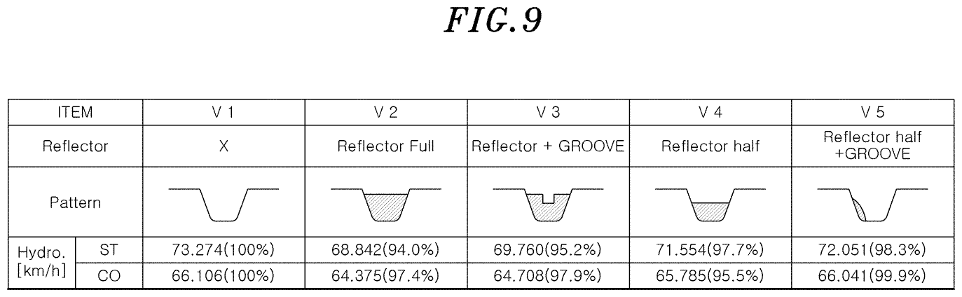

As illustrated in FIG. 9, even when the noise reflector 200 is disposed in the groove 110, drainage performance of the groove 110 is hardly affected. V1 illustrated in FIG. 9 represents the drainage performance of the tire in which the noise reflector is not present, and V5 represents the drainage performance of the tire to which the noise reflector 200 of the present disclosure is applied. In addition, V2, V3, and V4 represent the tire drainage performance in a state in which protrusions of different shapes are applied to the groove. ST represents tire drainage performance in a straight traveling state, and CO represents tire drainage performance in a cornering state. According to FIG. 9, it can be seen that V5 to which the noise reflector 200 of the present disclosure is applied has drainage performance better than those of V2, V3, and V4 in ST and CO states. In addition, the drainage performance of V5 may be close to the drainage performance of V1. In other words, even when the noise reflector 200 of the present disclosure is applied to the groove 110, the groove 110 can efficiently discharge water.

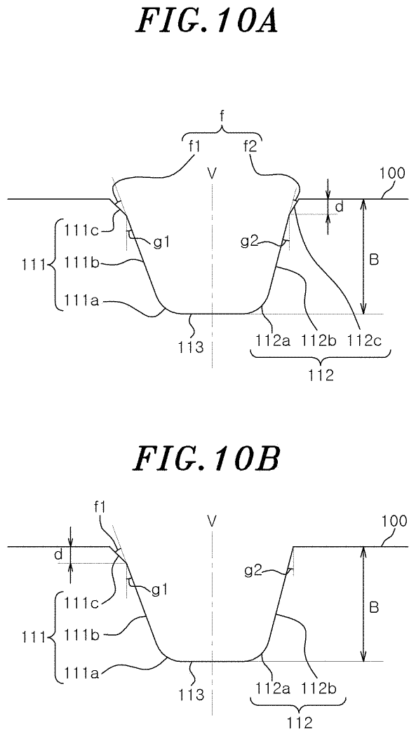

Hereinafter, a pneumatic tire 1 according to a second embodiment of the present disclosure will be described with reference to FIGS. 10A and 10B. As compared with the first embodiment described above, in the second embodiment of the present disclosure, at least one of the plurality of groove side surfaces 111 and 112 may further include surface connection surfaces 111c and 112c. Hereinafter, these differences will be mainly described, and the same description and reference numerals refer to the above-described embodiments.

The surface connection surfaces 111c and 112c may be located between the inclined surfaces 111b and 112b and the surface of the tread portion 100. A length “d” of each of the surface connection surfaces 111c and 112c in the radial direction of the pneumatic tire 1 may be 25% or less of a length “B” from the surface of the tread portion 100 to the groove bottom surface 113. In addition, the surface connection surfaces 111c and 112c may be inclined to be further away from the virtual surface “V” in order to form a predetermined angle “f” with the inclined surfaces 111b and 112b. For example, the angle “f” of each of the inclined surface connection surfaces 111c and 112c may be 30° or less based on the inclined surfaces 111b and 112b. In other words, the surface connection surfaces 111c and 112c may be inclined more than the inclined surfaces 111b and 112b with respect to the virtual surface V.

These surface connection surfaces 111c and 112c may be included in one or more of the plurality of groove side surfaces 111 and 112. As an example, referring to FIG. 10A, the first groove side surface 111 may include a first surface connection surface 111c disposed between the first inclined surface 111b and the surface of the tread portion 100, and the second groove side surface 112 may include a second surface connection surface 112c disposed between the second inclined surface 112b and the surface of the tread portion 100. As another example, referring to FIG. 10B, the first groove side surface 111 may include a first surface connection surface 111c, and the second inclined surface 112b of the second groove side surface 112 may be directly connected to the surface of the tread portion 20. As still another example, the second groove side 112 may include a second surface connection surface 112c, and the first inclined surface 111b of the first groove side surface 111 may be directly connected to the surface of the tread portion 100. In addition, the angle “f1” between the first surface connection surface 111c and the first inclined surface 111b and the angle “f2” between the second surface connection surface 112c and the second inclined surface 112b may be formed equal to or different from each other.

Hereinafter, operation and effects of the pneumatic tire 1 according to the second embodiment of the present disclosure will be described.

When the noise reflector 200 is applied to the groove 110, an area of the groove 110 may be reduced, and thus, the drainage performance may be reduced compared to V1 as described above. When at least one of the plurality of groove side surfaces 111 and 112 includes the surface connection surfaces 111c and 112c, an area of the groove 110 can be further secured (the area is increased), and thus, reduced drainage performance can be supplemented.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A pneumatic tire for reducing noise comprising:
a tread portion including a tread surface for making contacting with a road surface, and a groove recessed inward from the tread surface and extending along a circumferential direction of the pneumatic tire; and
a plurality of noise reflectors protruding from the groove and disposed spaced apart from each other along the circumferential direction of the pneumatic tire,
wherein the groove includes:
a groove bottom surface spaced apart by a predetermined distance from the tread surface in a radial direction of the pneumatic tire; and
a plurality of groove side surfaces connected to the groove bottom surface, each of the side groove surfaces including a connection curved surface having a predetermined curvature,
wherein each of the noise reflectors includes:
a support surface supported by the connection curved surface and the groove bottom surface; and
a protrusion surface located on a side opposite to the support surface and disposed to be spaced apart from the connection curved surface, and
wherein the protrusion surface includes a protruding curved surface having a shape which goes away from a central virtual plane perpendicular to the groove bottom surface as it goes from the groove bottom surface toward an outer side in the radial direction of the pneumatic tire.

2. The pneumatic tire of claim 1, wherein the pneumatic tire has a meridian plane passing through a center of the pneumatic tire and perpendicular to an axial direction of the tire,
the plurality of groove side surface includes a first groove side surface and a second groove side surface,
the first groove side surface and the second groove side surface are inclined so that an axial gap therebetween decreases as it goes to the groove bottom surface from the tread surface, and
each of the first groove side surface and the second groove side surface extends to be inclined with respect to the meridian surface.

3. The pneumatic tire of claim 1, wherein a height of the noise reflector in the radial direction is ½ or more of a length between the tread surface and the groove bottom surface.

4. The pneumatic tire of claim 1, wherein a thickness of the noise reflector in the circumferential direction is equal to or smaller than a separation distance between centers of the plurality of noise reflectors in the circumferential direction.

5. The pneumatic tire of claim 2, wherein the tread portion further includes a sipe recessed inward from the tread surface and extending in a direction deviating from an extension direction of the groove to be connected to the groove, and
the noise reflector is disposed to be spaced apart from the sipe in the circumferential direction of the pneumatic tire.
